(19) United States
(12) Patent Application Publication
(10) Pub. No.: US 2025/0269702 A1
(43) Pub. Date: Aug. 28, 2025

(54) SIDE STRUCTURE OF VEHICLE BODY

(71) Applicants: Hyundai Motor Company, Seoul (KR); Kia Corporation, Seoul (KR)

(72) Inventors: HaeHoon Lee, Hwaseong-si (KR); Hoyeon Kim, Hwaseong-si (KR)

(21) Appl. No.: 18/966,912

(22) Filed: Dec. 3, 2024

(30) Foreign Application Priority Data
Feb. 22, 2024 (KR) 10-2024-0025567

(51) Int. Cl. B60J 1/00; B60J 1/10; B62D 63/02

(52) U.S. Cl. CPC B60J 1/007; B60J 1/10; B62D 63/025

(57) ABSTRACT

A side structure of a vehicle body can include a rear quarter assembly having a quarter glass opening flange formed therein, a side outer assembly connected to the rear quarter assembly, and a quarter glass opening bracket mounted on the quarter glass opening flange and connected to the side outer assembly. The rear quarter assembly can be modular to accommodate one or more different side outer assembly options, such as a side outer assembly including a quarter glass opening configured to receive a quarter glass window therein or a side outer assembly having a quarter glassless portion of skin type.

### CROSS-REFERENCE TO RELATED APPLICATIONS

This application claims priority to and the benefit of Korean Patent Application No. 10-2024-0025567 filed in the Korean Intellectual Property Office on Feb. 22, 2024, the entire contents of which are incorporated herein by reference.

### TECHNICAL FIELD

The present disclosure relates to a side structure of a vehicle body.

### BACKGROUND

Recently, the vehicle industry is introducing a new concept of future mobility vision for realizing a human-centered, dynamic future city. One of these future mobility solutions is a Purpose Built Vehicle (PBV) as purpose-based mobility.

An example of a PBV is an electric vehicle (EV)-based environmentally-friendly mobility vehicle. These PBVs can provide various customized services to users. PBV can be configured in various forms depending on the type of customized service.

For example, the PBV can be used as a hailing type vehicle to transport occupants by configuring cabins in the front and rear of the vehicle body. Additionally, the PBV can be utilized as a delivery type vehicle with a cabin in the front part of the vehicle body and a luggage room in the rear part of the vehicle body.

In the case of the hailing type vehicle, the structure is such that the quarter glass is mounted on the rear of the vehicle body. In the case of delivery type vehicles, the structure is such that the quarter glass is not mounted on the rear of the vehicle body.

Accordingly, a side structure of a vehicle body that corresponds to the specifications of various body types, such as the hailing type vehicle and the delivery type vehicle, as a vehicle type of PBV is required, and a side structure of a vehicle body that enables combination production by specification through common use of molds and parts is required.

The information contained in this Background section has been prepared to provide understanding of the background of the present disclosure and may include matters that are not prior art and not already publicly known, available, or in use.

### SUMMARY

The present disclosure relates to a vehicle body. More particularly, the present disclosure relates to a side structure of a vehicle body that can be adapted to various vehicle types.

An embodiment of the present disclosure can provide a side structure of a vehicle body that can accommodate vehicle bodies with different specifications depending on the vehicle type by enabling common use of molds and parts.

A side structure of a vehicle body according to an embodiment may include a rear quarter assembly having a quarter glass opening flange formed therein, a side outer assembly connected to the rear quarter assembly, and a quarter glass opening bracket mounted on the quarter glass opening flange and connected to the side outer assembly.

The side outer assembly may include a quarter glass mount flange connected to the quarter glass opening bracket.

The quarter glass opening bracket may be connected to the quarter glass opening flange and the quarter glass mount flange by welding.

The side outer assembly may include a quarter glassless portion of skin type connected to the quarter glass opening bracket.

The quarter glass opening bracket may be connected to the quarter glass opening flange by welding, and connected to the quarter glassless portion by a sealer.

The quarter glass opening bracket may include an outer edge connected to the quarter glass opening flange, and an inner edge extending in the side outward direction through a stepped portion from the outer edge and connected to the side outer assembly.

The outer edge may be connected by welding to the quarter glass opening flange.

The inner edge may be connected to a quarter glass mount flange formed on the side outer assembly by welding.

The inner edge may be positioned at a predetermined interval from a quarter glassless portion formed on the side outer assembly, and connected to the quarter glassless portion by a sealer.

The quarter glass opening bracket may further include a reinforcement portion connecting at least a portion of the inner edge.

At least two split opening sections may be formed in the reinforcement portion of the quarter glass opening bracket.

At least one slot may be formed in the reinforcement portion.

A first assembly process of assembling the rear quarter assemblies may be performed.

After the first assembly process, a second assembly process may be performed to connect the quarter glass opening bracket to the quarter glass opening flange formed in the rear quarter assemblies.

After the second assembly process, a third assembly process may be performed to connect the quarter glass opening bracket and the side outer assembly.

In the third assembly process, the quarter glass mount flange formed on the side outer assembly and the quarter glass opening bracket may be connected by welding.

In the third assembly process, a process may be performed to connect the quarter glassless portion formed in the side outer assembly and the quarter glass opening bracket with a sealer.

In a side structure of a vehicle body according to an embodiment of the present disclosure, because common use of a mold and common use of parts can be possible, the mold investment cost can be reduced, the assemble productivity can be improved, and the appearance quality of the delivery type vehicle type can be improved.

Advantages that can be obtained or expected from an embodiment of the present disclosure are directly or implicitly disclosed in the detailed description of example embodiments of the present disclosure. Various advantages predicted according to embodiments of the present disclosure will be disclosed in the detailed description to be provided later.

### BRIEF DESCRIPTION OF THE DRAWINGS

Because the drawings are for reference in explaining example embodiments of the present disclosure, technical ideas of the present disclosure should not be interpreted as necessarily limited to the attached drawings.

FIG. 1 is a side view illustrating a side structure of a vehicle body according to a first embodiment of the present disclosure.

FIG. 2 and FIG. 3 are exploded perspective views illustrating a side structure of a vehicle body according to a first embodiment of the present disclosure.

FIG. 4 is a cross-sectional view taken along line A-A of FIG. 1.

FIG. 5 is a perspective view illustrating a quarter glass opening bracket that can be applied to a side structure of a vehicle body according to a first embodiment of the present disclosure.

FIG. 6 is a side view illustrating a side structure of a vehicle body according to a second embodiment of the present disclosure.

FIG. 7 and FIG. 8 are exploded perspective views illustrating a side structure of a vehicle body according to a second embodiment of the present disclosure.

FIG. 9 is a cross-sectional view taken along line B-B of FIG. 6.

FIG. 10 is a perspective view illustrating a quarter glass opening bracket that can be applied to a side structure of a vehicle body according to a second embodiment of the present disclosure.

It can be understood that the drawings referenced above are not necessarily drawn to scale, but rather present rather simplified representations of various features illustrating some basic principles through example embodiments of the present disclosure. For example, certain design features of an embodiment of the present disclosure, including particular dimensions, direction, position, and shape, can be determined in part by a particular intended application and usage environment.

### DETAILED DESCRIPTION OF ILLUSTRATIVE EMBODIMENTS

Hereinafter, with reference to the attached drawings, example embodiments of the present disclosure will be described in detail so that those skilled in the art can easily implement an embodiment of the present disclosure. As those skilled in the art would realize, the described example embodiments may be modified in various different ways, without departing from the spirit or scopes of the present disclosure.

The terminology used herein is for the purpose of describing particular example embodiments and is not intended to necessarily limit the present disclosure. As used herein, singular forms can be intended to include plural forms as well, unless the context clearly indicates otherwise.

It can be understood that the terms “comprises” and/or “comprising” as used herein indicate the presence of stated features, integers, steps, operations, elements, and/or components, but do not preclude the presence or addition of one or more other features, integers, steps, operations, components, and/or groups thereof.

As used herein, the term “and/or” includes any and all combinations of one or more of the associated listed items.

In the detailed description below, the names of the components can be divided into “first,” “second,” etc., to distinguish them when the components are in a similar relationship, and the description below is not necessarily limited to that order based on such adjectives.

The term “connected” in this specification can denote a physical relationship between two components that are directly connected to each other or indirectly connected through one or more intermediary components.

As used herein, “vehicle,” “vehicular,” “automotive,” or other similar terms as used herein, generally can refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, example embodiments of the present disclosure will be described in detail with reference to the attached drawings.

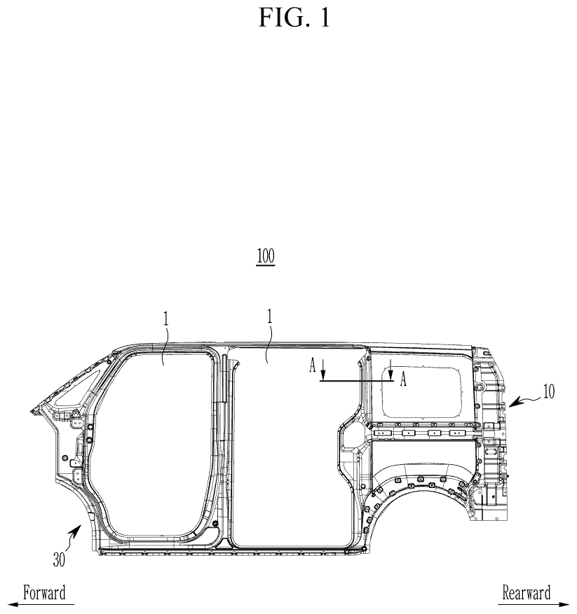

FIG. 1 is a side view illustrating a side structure of a vehicle body according to a first embodiment of the present disclosure.

The side structure of a vehicle body 100 according to the first embodiment of the present disclosure, referring to FIG. 1, can be applied to, for example, a vehicle body of a purpose-based mobility vehicle (hereinafter, referred to as ‘PBV’).

The PBV can be used as an electric car-based life module vehicle that moves in a manned or unmanned autonomous manner and provides various customized services to users.

The vehicle body of these PBVs can be configured in various shapes depending on the intended use of the PBV.

In this specification, the reference direction for describing the components below may be set as the vehicle body front-rear direction (e.g., vehicle body length direction or longitudinal direction), vehicle width direction (e.g., left-right direction or lateral direction), and vertical direction (e.g., height direction) with the vehicle body as reference.

In this specification, “upper end,” “upper portion,” or “upper surface” of a component can indicate an end, portion, or surface of a component that is relatively upper in the drawing, and “lower end,” “lower portion,” or “lower surface” of a component can indicate an end, portion, or surface of a component that is relatively lower in the drawing.

Furthermore, in this specification, an end of a component (e.g., one end or another (other) end, etc.) can denote an end of a component in any one direction, and an end portion of the component (e.g., one end portion) or other (another) end portion, etc.) can denote a portion of a component that includes that end.

The side structure of a vehicle body 100 according to the first embodiment of the present disclosure can be applied to a PBV vehicle body of a hailing vehicle type having a cabin 1 configured in the front and rear parts to transport occupants.

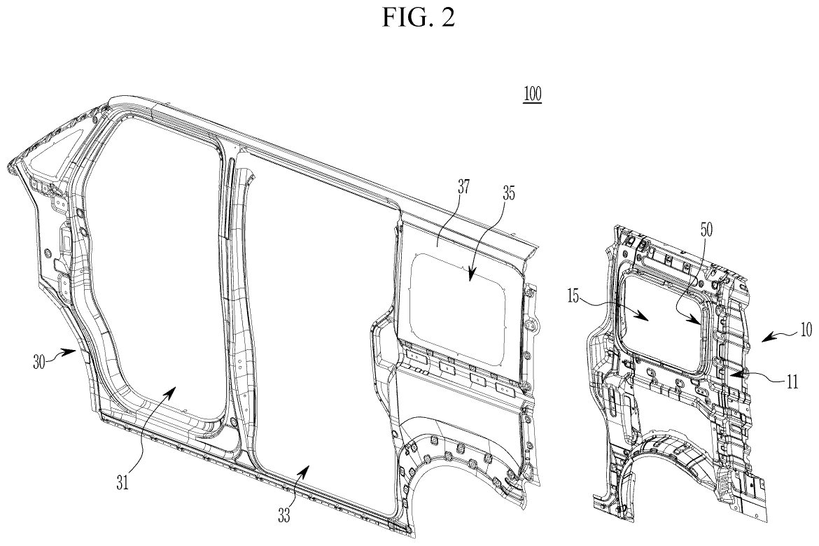

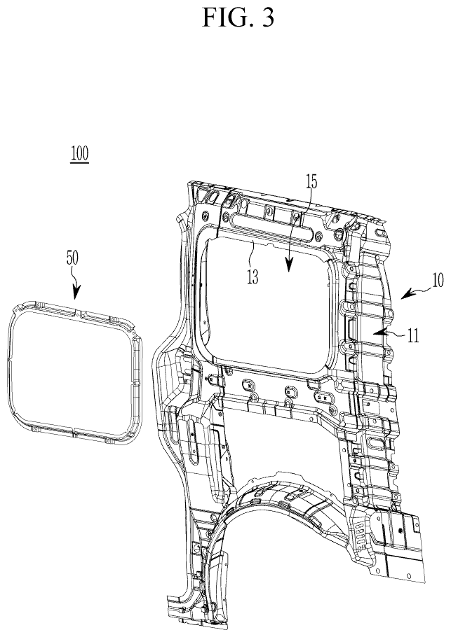

FIG. 2 and FIG. 3 are exploded perspective views illustrating a side structure of a vehicle body according to a first embodiment of the present disclosure.

Referring to FIG. 1 to FIG. 3, the side structure of a vehicle body 100 according to a first embodiment of the present disclosure can include a rear quarter assembly 10, a side outer assembly 30, and a quarter glass opening bracket 50.

In an embodiment, the rear quarter assembly 10 can be positioned at the rear of the vehicle body and may be composed of a combination of a plurality of rear quarter parts 11. The configuration of the rear quarter parts 11 can be apparent to those skilled in the art, e.g., based on the drawings, so a detailed description is omitted.

The rear quarter assembly 10 can include a quarter glass opening flange 13. The quarter glass opening flange 13 can be formed at an edge of a quarter glass opening section 15 formed in the rear quarter assembly 10.

In an embodiment, the side outer assembly 30 can be connected to the rear quarter assembly 10. The side outer assembly 30 may be formed by a press mold, for example.

The side outer assembly 30 can include, in one example, a front door mount section 31, a sliding door mount section 33, and a quarter glass mount section 35.

The quarter glass mount section 35 can be connected to the quarter glass opening section 15 of the rear quarter assembly 10.

The side outer assembly 30 can include a quarter glass mount flange 37 formed at an edge portion of the quarter glass mount section 35. The quarter glass mount flange 37 can be formed at a position corresponding to the quarter glass opening flange 13 of the rear quarter assembly 10.

In an embodiment, the quarter glass opening bracket 50 can be configured to support a quarter glass (not shown in the drawing).

The quarter glass opening bracket 50 can be mounted on the quarter glass opening flange 13 of the rear quarter assembly 10 and can be connected to the side outer assembly 30.

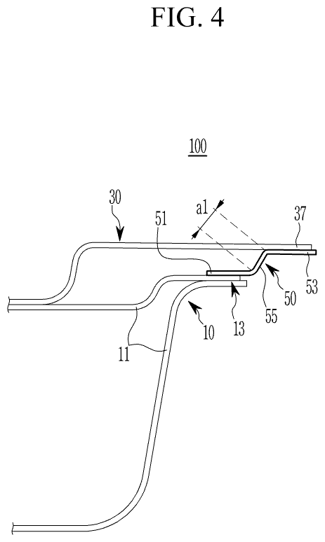

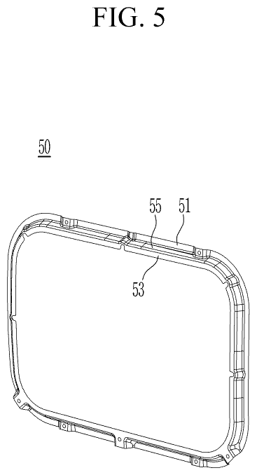

FIG. 4 is a cross-sectional view taken along line A-A of FIG. 1. FIG. 5 is a perspective view illustrating a quarter glass opening bracket that can be applied to a side structure of a vehicle body according to a first embodiment of the present disclosure.

The quarter glass opening bracket 50, referring to FIGS. 2 to 5, according to an embodiment, may be provided in a rounded quadrangle shape, in one example.

The quarter glass opening bracket 50 may be connected to the quarter glass opening flange 13 of the rear quarter assembly 10 and the quarter glass mount flange 37 of the side outer assembly 30 by welding, for example.

Specifically describing the configuration of the quarter glass opening bracket 50, the quarter glass opening bracket 50 can include an outer edge 51 and an inner edge 53. Here, outer can refer to the outer edge direction of a round quadrangle, and inner can refer to the inner edge direction of a round quadrangle.

The outer edge 51 of the quadrangle can be connected by welding to the quarter glass opening flange 13 of the rear quarter assembly 10.

The inner edge 53 can extend in a side outward direction from the outer edge 51 through a stepped portion 55. The inner edge 53 can be connected to the quarter glass mount flange 37 of the side outer assembly 30 by welding.

The stepped portion 55 can extend from the outer edge 51 along the side outer direction with a first step width a1 and can be connected to the inner edge 53.

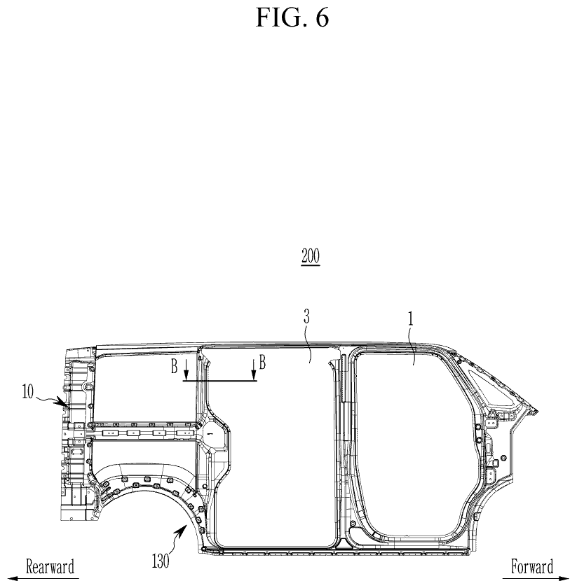

FIG. 6 is a side view illustrating a side structure of a vehicle body according to a second embodiment of the present disclosure.

Referring to FIG. 6, the side structure of a vehicle body 200 according to the second embodiment of the present disclosure can be applied to a PBV vehicle body of a delivery vehicle type having a cabin 1 configured in the front part and a luggage room 3 configured in the rear part to transport various loads.

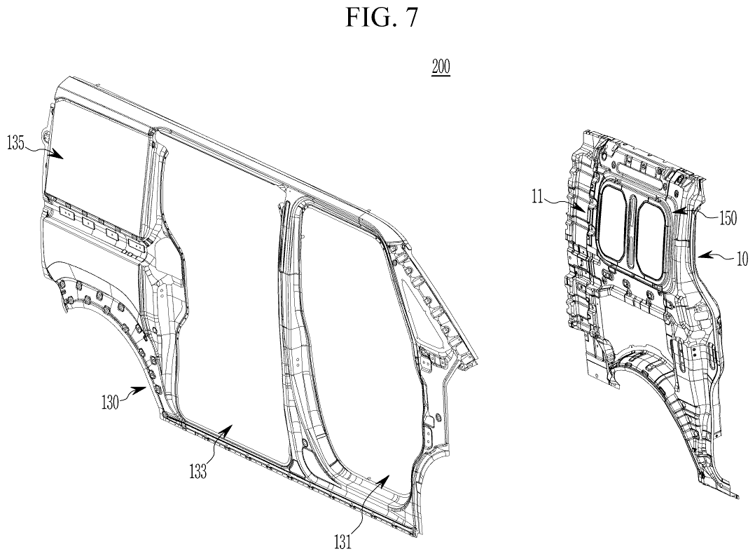

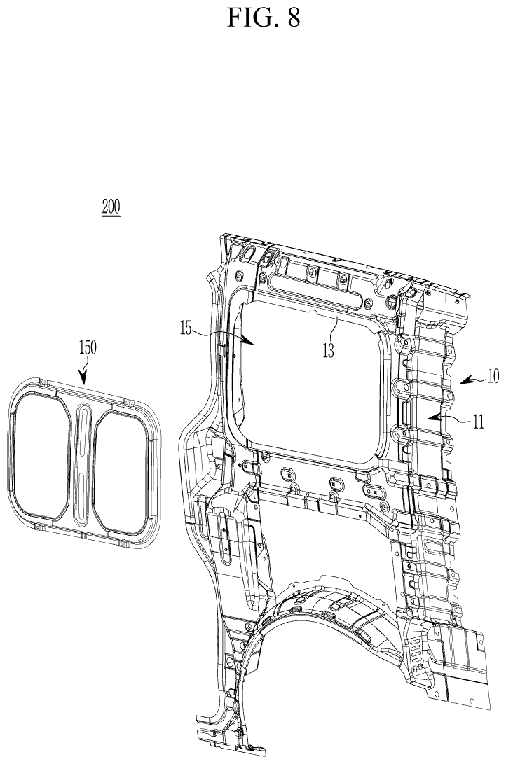

FIG. 7 and FIG. 8 are exploded perspective views illustrating a side structure of a vehicle body according to a second embodiment of the present disclosure.

For convenience of understanding, the same drawing reference numerals are given to the same components as the side structure of a vehicle body according to the first embodiment of the present disclosure described in FIGS. 1 to 5.

Referring to FIGS. 6 to 8, a side structure of a vehicle body 200 according to a second embodiment of the present disclosure can include a rear quarter assembly 10, a side outer assembly 130, and a quarter glass opening bracket 150.

In an embodiment, the rear quarter assembly 10 can be positioned at the rear of the vehicle body and may be composed of a combination of a plurality of rear quarter parts 11. The configuration of the rear quarter parts 11 can be apparent to those skilled in the art, e.g., based on the drawings, so a detailed description is omitted.

The rear quarter assembly 10 may be composed of common module parts identical to the rear quarter parts 11 of the rear quarter assembly 10 applied to the PBV vehicle body of the hailing vehicle type according to the first embodiment.

The rear quarter assembly 10 can include a quarter glass opening flange 13. The quarter glass opening flange 13 can be formed at the edge of the quarter glass opening section 15 formed in the rear quarter assembly 10.

In an embodiment, the side outer assembly 130 can be connected to the rear quarter assembly 10. The side outer assembly 130 may be formed by a press mold, for example.

The side outer assembly 130 can include, in one example, a front door mount section 131, a sliding door mount section 133, and a quarter glassless portion 135.

The quarter glassless portion 135 can be formed at a position corresponding to the quarter glass opening section 15 of the rear quarter assembly 10. The quarter glassless portion 135 can be formed as a skin surface type and can be formed as a part of the rear skin surface of the side outer assembly 130.

In an embodiment, the quarter glass opening bracket 150 can be configured to support the quarter glassless portion 135 of the side outer assembly 130. That is, the quarter glass opening bracket 150 can support the quarter glassless portion 135 of the skin type rather than supporting the quarter glass.

The quarter glass opening bracket 150 can be mounted on the quarter glass opening flange 13 of the rear quarter assembly 10 and can be connected to the side outer assembly 130.

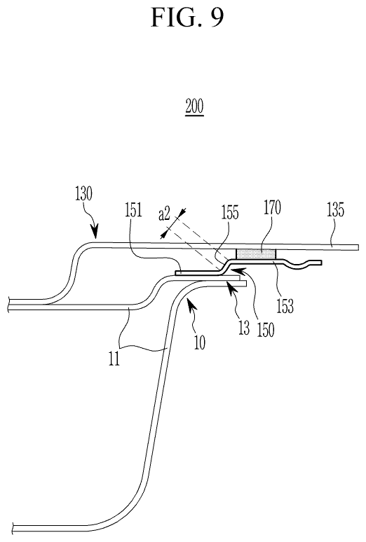

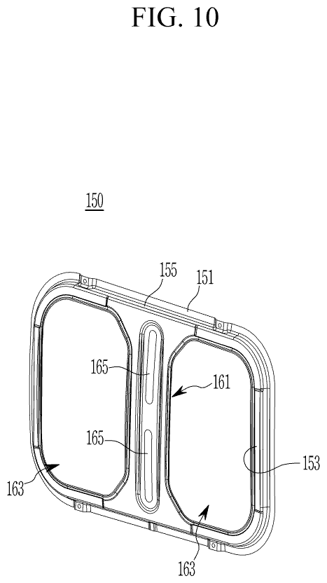

FIG. 9 is a cross-sectional view taken along line B-B of FIG. 6. FIG. 10 is a perspective view illustrating a quarter glass opening bracket that can be applied to a side structure of a vehicle body according to a second embodiment of the present disclosure.

Referring to FIGS. 7 to 10, the quarter glass opening bracket 150 according to an embodiment can include, in one example, a rounded quadrangle type edge portion.

The quarter glass opening bracket 150 can be connected to the quarter glass opening flange 13 of the rear quarter assembly 10 by welding, and can be connected to the quarter glassless portion 135 of the side outer assembly 130 by a sealer 170, for example.

Specifically describing the configuration of the quarter glass opening bracket 150, the quarter glass opening bracket 150 can include an outer edge 151, an inner edge 153, and a reinforcement portion 161.

The outer edge 151 can be connected by welding to the quarter glass opening flange 13 of the rear quarter assembly 10.

The inner edge 153 can extend in a side outward direction from the outer edge 151 through a stepped portion 155. The inner edge 153 can be positioned at a predetermined gap from the quarter glassless portion 135 of the side outer assembly 130 and can be connected to the quarter glassless portion 135 by a sealer 170.

The stepped portion 155 can be formed with a second step width a2 (see, e.g., FIG. 9) smaller than the first step width a1 of the quarter glass opening bracket 50 according to the first embodiment as illustrated in FIG. 4.

The reinforcement portion 161 can be configured to reinforce the strength of the outer plate/panel of the quarter glassless portion 135 of the side outer assembly 130. The reinforcement portion 161 can have a predetermined width and connect at least a portion of the inner edge 153.

The reinforcement portion 161 may, in one example, connect the inner edge 153 formed at the upper portion and the inner edge 153 formed at the lower portion thereof, using the drawing as a reference. However, the reinforcement portion 161 is not necessarily limited thereto, and the reinforcement portion 161 may also connect the inner edge 153 formed in the forward direction of the vehicle body and the inner edge 153 formed in the rearward direction of the vehicle body, for example.

The reinforcement portion 161 can include at least two split opening sections 163 in the quarter glass opening bracket 150, for example, two split opening sections 163 as shown in FIG. 10.

The reinforcement portion 161 can include at least one slot 165. The at least one slot 165 can be formed along the vertical direction in the reinforcement portion 161, with reference to the drawing, in one example. In another example, the at least one slot 165 may be formed by two slots spaced along the vertical direction in the reinforcement portion 161.

When the reinforcement portion 161 is formed in the length direction of the vehicle body, the at least one slot 165 may be formed in the length direction of the vehicle body, for example.

This at least one slot 165 can be configured to easily disperse the load applied to the quarter glassless portion 135 of the side outer assembly 130 to the reinforcement portion 161.

The reinforcement portion 161 as described above can be connected to the quarter glassless portion 135 via an adhesive unit including a sealer, for example.

Hereinafter, the assembly process of the side structures of a vehicle body 100 and 200 according to the first and second example embodiments of the present disclosure configured as described above will be described in detail with reference to FIGS. 1 to 10.

The side outer assembly 30 according to the first embodiment can be provided, formed into a predetermined shape.

The side outer assembly 30 according to the first embodiment can be formed with the front door mount section 31, the sliding door mount section 33, the quarter glass mount section 35, and the quarter glass mount flange 37.

Additionally or alternatively, the side outer assembly 130 according to the second embodiment formed into a predetermined shape can be provided.

The side outer assembly 130 according to the second embodiment can be formed with the front door mount section 131, the sliding door mount section 133, and the quarter glassless portion 135.

The side outer assemblies 30 and 130 according to the first embodiment and the second embodiment, respectively, can be formed by a press mold.

To elaborate, in the molded structures of the side outer assemblies 30 and 130 according to the first embodiment and the second embodiment, respectively, the molded structures of the remaining regions except for the quarter glass mount section 35 and the quarter glassless portion 135 can be the same.

Accordingly, in the press mold for forming the side outer assemblies 30 and 130 according to the first embodiment and the second embodiment, respectively, the remaining forming units except for the trim unit for trimming the quarter glass mount section 35 can be the same.

The press mold can form the side outer assemblies 30 and 130 according to the first embodiment and the second embodiment, respectively, in a selective trimming manner.

Accordingly, it can be possible to commonize (e.g., make the same or mostly the same) the press mold for forming the side outer assembly 30 according to the first embodiment applied to the hailing vehicle type and the side outer assembly 130 according to the second embodiment applied to the delivery vehicle type.

As a result, in an embodiment of the present disclosure, the mold investment cost for forming the side outer assemblies 30 and 130 of different vehicle types can be reduced.

The quarter glass opening bracket 50 according to the first embodiment can be provided, and/or the quarter glass opening bracket 150 according to the second embodiment can be provided. The quarter glass opening brackets 50 and 150 according to the first embodiment and the second embodiment, respectively, can have different shapes.

Specifically, the quarter glass opening bracket 50 according to the first embodiment can include the outer edge 51 and the inner edge 53. The quarter glass opening bracket 150 according to the second embodiment can include the outer edge 151, the inner edge 153, and the reinforcement portion 161.

On the other hand, a process of assembling a plurality of rear quarter assemblies 10 according to the first embodiment and the second embodiment can be performed.

The rear quarter assembly 10 according to the first embodiment and the second embodiment can be assembled with the rear quarter parts 11 as common module parts. For example, a first assembly process can be performed. Accordingly, the common module parts of the rear quarter assemblies 10 can be assembled without relationship to the specifications of each vehicle type (e.g., hailing vehicle type and delivery vehicle type).

As a result, using an embodiment of the present disclosure, the mold investment cost for manufacturing rear quarter parts 11 of rear quarter assembly 10 for each vehicle type can be reduced, and the assembly productivity of rear quarter assembly 10 for each vehicle type can be improved.

After going through this process, an assembly process can be performed to connect the quarter glass opening brackets 50 and 150 according to the first embodiment and the second embodiment, respectively, to the quarter glass opening flange 13 of the rear quarter assemblies 10 to which common module parts are applied according to the vehicle type as described above. For example, a second assembly process can be performed.

The outer edge 51 of the quarter glass opening bracket 50 according to the first embodiment, and/or the outer edge 151 of the quarter glass opening bracket 150 according to the second embodiment, can be connected to the quarter glass opening flange 13 by welding.

Accordingly, by assembling the quarter glass opening brackets 50 and 150 according to the first embodiment and the second embodiment, respectively, having different shapes in the rear quarter assemblies 10 that can be standardized by vehicle type, it can be possible to distinguish the specifications of the rear quarter assemblies 10 by vehicle type.

Next, an assembly process can be performed to connect the side outer assembly 30 according to the first embodiment and the quarter glass opening bracket 50 according to the first embodiment. Additionally or alternatively, an assembly process can be performed to connect the side outer assembly 130 according to the second embodiment and the quarter glass opening bracket 150 according to the second embodiment. For example, a third assembly process can be performed.

In this assembly process, the inner edge 53 of the quarter glass opening bracket 50 according to the first embodiment can be connected to the quarter glass mount flange 37 of the side outer assembly 30 according to the first embodiment by welding.

Additionally or alternatively, the inner edge 153 of the quarter glass opening bracket 150 according to the second embodiment can be connected to the quarter glassless portion 135 of the side outer assembly 130 according to the second embodiment by the sealer 170. And, the reinforcement portion 161 of the quarter glass opening bracket 150 according to the second embodiment can be connected to the quarter glassless portion 135 through an adhesive unit including a sealer.

Because the inner edge 153 of the quarter glass opening bracket 150 according to the second embodiment can be connected to the quarter glassless portion 135 of the side outer assembly 130 according to the second embodiment using the sealer 170, the vehicle body appearance quality of the delivery vehicle type can be improved.

Accordingly, the side structures of a vehicle body 100 and 200 according to first and second example embodiments of the present disclosure, respectively, can be assembled through a series of processes as described above.

The side structure of a vehicle body 100 and 200 according to the first and second example embodiments of the present disclosure, respectively, can secure production flexibility because the specifications of the rear quarter assembly 10 can be distinguished by vehicle type based on which of the quarter glass opening brackets (50 or 150) is used.

Accordingly, the side structures of a vehicle body 100 and 200 according to the first and second example embodiments of the present disclosure, respectively, can be produced in mixed quantities according to specifications, thereby improving production efficiency.

Based on the side structure of a vehicle body 100 and 200 according to the first and second example embodiments of the present disclosure, respectively, described so far, because common use of the mold and common use of parts can be possible, the mold investment cost can be reduced, the assemble productivity can be improved, and the vehicle body appearance quality of the delivery type vehicle can be improved.

Although the example embodiments of the present disclosure have been described above, the present disclosure is not necessarily limited thereto, and various modifications may be made within the scopes of the claims, the detailed description of the present disclosure, and the attached drawings, and equivalents thereof, which can also fall within the scopes of the present disclosure.

What is claimed is:

1. A side structure of a vehicle body comprising:
a rear quarter assembly having a quarter glass opening flange formed therein;
a side outer assembly connected to the rear quarter assembly; and
a quarter glass opening bracket mounted on the quarter glass opening flange and connected to the side outer assembly.

2. The side structure of claim 1, wherein the side outer assembly comprises a quarter glass mount flange connected to the quarter glass opening bracket.

3. The side structure of claim 2, wherein the quarter glass opening bracket is connected to the quarter glass opening flange and the quarter glass mount flange by welding.

4. The side structure of claim 1, wherein the side outer assembly comprises a quarter glassless portion of skin type connected to the quarter glass opening bracket.

5. The side structure of claim 4, wherein the quarter glass opening bracket is connected to the quarter glass opening flange by welding, and wherein the quarter glass opening bracket is connected to the quarter glassless portion by a sealer.

6. The side structure of claim 1, wherein the quarter glass opening bracket comprises:
an outer edge connected to the quarter glass opening flange; and
an inner edge extending in a side outward direction through a stepped portion from the outer edge and connected to the side outer assembly.

7. The side structure of claim 6, wherein the outer edge is connected by welding to the quarter glass opening flange.

8. The side structure of claim 7, wherein the inner edge is connected to a quarter glass mount flange formed on the side outer assembly by welding.

9. The side structure of claim 7, wherein the inner edge is positioned at a predetermined interval from a quarter glassless portion formed on the side outer assembly, and wherein the inner edge is connected to the quarter glassless portion by a sealer.

10. The side structure of claim 6, wherein the quarter glass opening bracket further comprises a reinforcement portion connecting to at least a portion of the inner edge.

11. The side structure of claim 10, wherein at least two split opening sections are formed in the reinforcement portion of the quarter glass opening bracket.

12. The side structure of claim 10, wherein at least one slot is formed in the reinforcement portion.

13. The side structure of claim 1, wherein the rear quarter assembly is provided by a first assembly process.

14. The side structure of claim 13, wherein after the first assembly process, the quarter glass opening bracket mounted on the quarter glass opening flange is provided by a second assembly process performed to connect the quarter glass opening bracket to the quarter glass opening flange.

15. The side structure of claim 14, wherein after the second assembly process, the quarter glass opening bracket connected to the side outer assembly is provided by a third assembly process performed to connect the quarter glass opening bracket and the side outer assembly.

16. The side structure of claim 15, wherein in the third assembly process, a quarter glass mount flange formed on the side outer assembly and the quarter glass opening bracket are connected by welding.

17. The side structure of claim 15, wherein in the third assembly process, an operation is performed to connect a quarter glassless portion formed in the side outer assembly and the quarter glass opening bracket with a sealer.

18. A side structure of a vehicle body comprising:
a modular rear quarter assembly having a modular quarter glass opening flange formed therein;
a first side outer assembly or a second side outer assembly connected to the modular rear quarter assembly, wherein the first side outer assembly differs from the second side outer assembly; and
a first quarter glass opening bracket or a second quarter glass opening bracket mounted on the modular quarter glass opening flange, wherein the first quarter glass opening bracket differs from the second quarter glass opening bracket,
wherein if the first side outer assembly is connected to the modular rear quarter assembly, then the first quarter glass opening bracket is mounted on the modular quarter glass opening flange, and the first quarter glass opening bracket is connected to the first side outer assembly, and
wherein if the second side outer assembly is connected to the modular rear quarter assembly, then the second quarter glass opening bracket is mounted on the modular quarter glass opening flange, and the second quarter glass opening bracket is connected to the second side outer assembly.

19. The side structure of claim 18, wherein if the first side outer assembly is connected to the modular rear quarter assembly, then the first side outer assembly comprises a quarter glass mount flange connected to the first quarter glass opening bracket, and the first quarter glass opening bracket is connected to the modular quarter glass opening flange and the quarter glass mount flange by welding.

20. The side structure of claim 18, wherein if the second side outer assembly is connected to the modular rear quarter assembly, then the second side outer assembly comprises a quarter glassless portion of skin type connected to the second quarter glass opening bracket, the second quarter glass opening bracket is connected to the modular quarter glass opening flange by welding, and the second quarter glass opening bracket is connected to the quarter glassless portion by a sealer.
